(19) United States
(12) Patent Application Publication
(10) Pub. No.: US 2011/0315027 A1
(43) Pub. Date: Dec. 29, 2011

(54) NAIL PRINTING APPARATUS

(75) Inventor: Hiroyasu BITOH, Ome-shi (JP)

(73) Assignee: CASIO COMPUTER CO., LTD., Tokyo (JP)

(21) Appl. No.: 13/166,931

(22) Filed: Jun. 23, 2011

(30) Foreign Application Priority Data
Jun. 25, 2010 (JP) 2010-144545
Jun. 25, 2010 (JP) 2010-144552
Jun. 25, 2010 (JP) 2010-144554

(51) Int. Cl. B41F 17/00

(52) U.S. Cl. 101/35

(57) ABSTRACT

A nail printing apparatus is provided with a main body including a held portion which has a print target finger placing surface and a non-print-target finger placing surface. The print target finger placing surface is configured in such a manner that at least one finger with a nail, on which a desired image is to be printed, of one hand is placed thereon. The non-print-target finger placing surface is configured in such a manner that at least one remaining finger of the one hand is placed thereon. The held portion is held between the at least one finger on the print target finger placing surface and the at least one remaining finger on the non-print-target placing surface. The apparatus is further provided with an image printing unit configured to print the desired image on the nail of the at least one finger on the print target finger placing surface.

### CROSS-REFERENCE TO RELATED APPLICATIONS

This application is based upon and claims the benefit of priority from prior Japanese Patent Applications No. 2010-144545, filed Jun. 25, 2010; No. 2010-144552, filed Jun. 25, 2010; and No. 2010-144554, filed Jun. 25, 2010, the entire contents of all of which are incorporated herein by reference.

### BACKGROUND OF THE INVENTION

1. Field of the Invention

The present invention relates to a nail printing apparatus used for printing a desired image on a nail.

2. Description of the Related Art

A conventional nail printing apparatus comprises a print target finger stage on which a finger with a nail on which a desired image is to be printed (which will be referred to as a print target finger hereinafter) is placed at a predetermined position, and a printing unit that prints the desired image on the nail of the print target finger placed at the predetermined position on the print target finger stage.

When the print target finger is just placed at the predetermined position on the print target finger stage, a change in posture of the print target finger at the predetermined position or a movement of the print target finger from the predetermined position is produced due to a movement of a hand, an arm or a body.

When the change in posture or the movement is produced during printing of a desired image by the printing unit with respect to the nail of the print target finger placed at the predetermined position on the print target finger stage, desired printing of the desired image with respect to the nail of the print target finger is not carried out correctly as a matter of course.

To avoid occurrence of such a problem, a nail printing apparatus comprising a print target finger restraint instrument that restrains a print target finger placed at a predetermined position on a print target finger stage has been known from, e.g., Japanese Patent Application KOKAI Publication No. 2000-194838.

However, such a print target finger restraint instrument produces a sense of pressure in the print target finger of a user, and some users feel uncomfortable with this sense of pressure. Further, when the print target finger is unintentionally and suddenly moved while the print target finger is retrained by the print target finger restraint instrument, the print target finger may ache due to the print target finger restraint instrument in some cases.

### BRIEF SUMMARY OF THE INVENTION

This invention is derived from the above-described circumstances, an object of the present invention is to provide a nail printing apparatus that does not produce discomfort like a sense of pressure in a print target finger of a user, does not produce pain in the print target finger even if the print target finger is unintentionally and suddenly moved, and can prevent a change in posture or movement from occurring in the print target finger placed on the print target finger stage.

In order to achieve the above described object of the invention, a nail printing apparatus according to this invention comprises a main body including a held portion which has a print target finger placing surface and a non-print-target finger placing surface. The print target finger placing surface is configured in such a manner that at least one finger with a nail, on which a desired image is to be printed, of one hand is placed thereon. The non-print-target finger placing surface is configured in such a manner that at least one remaining finger of the one hand is placed thereon. And, the held portion is held between the at least one finger placed on the print target finger placing surface and the at least one remaining finger placed on the non-print-target placing surface.

The nail printing apparatus according to this invention further comprises an image printing unit configured to print the desired image on the nail of the at least one finger placed on the print target finger placing surface of the held portion of the main body.

In the nail printing apparatus according to the present invention, the held portion of the main body is held between the at least one finger with the nail, on which the desired image is to be printed, of the one hand placed on the print target finger placing surface of the held portion of the main body and the at least one remaining finger of the one hand placed on the non-print-target finger placing surface of the held portion. This holding stabilizes a posture of the at least one finger with the nail, on which the desired image is to be printed, of the one hand placed on the print target finger placing surface of the held portion of the main body. Therefore, a change in posture or movement can be prevented from occurring in the at least one finger. Furthermore, as different from a conventional nail printing apparatus, the at least one finger with the nail, on which the desired image is to be printed, of the one hand placed on the print target finger placing surface is not restrained by a restraint instrument. Therefore, discomfort like a sense of pressure is not produced in the print target finger of a user, and the print target finger does not ache even if the print target finger is unintentionally and suddenly moved.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view schematically showing an appearance of a nail printing apparatus according to an embodiment of the present invention;

FIG. 2 is a perspective view schematically showing an internal configuration of the nail print apparatus shown in FIG. 1;

FIG. 3 is a cross-sectional view schematically showing a state that four fingers with nails, on which desired images are to be printed, excepting a thumb of a left hand are placed on and arranged along a print target finger placing surface of a held portion of a main body of the internal configuration shown in FIG. 2 while the thumb of the left hand is placed on a non-print-target finger placing surface of the held portion, the held portion is held between the four fingers of the left hand and the thumb thereof, and the left four fingers are placed on the print target finger placing surface of the held portion of the main body to stabilize their postures and to prevent them from moving;

FIG. 4 is a cross-sectional view showing a state that a thumb of a left hand with a nail, on which a desired image is to be printed, is placed on the print target finger placing surface of the held portion of the main body of the internal configuration shown in FIG. 2, four fingers excepting the thumb of the left hand are placed on and arranged along the non-print-target finger placing surface of the held portion, and the held portion is held between the four fingers of the left hand and the thumb thereof, and the thumb is placed on the print target finger placing surface of the held portion of the main body to stabilize its posture and to prevent it from moving;

FIG. 5A is a schematic plan view showing an example of antislip grooves provided on the print target finger placing surface of the held portion of the main body of the internal configuration shown in FIG. 2;

FIG. 5B is a schematic plan view showing another example of antislip grooves provided on the print target finger placing surface of the held portion of the main body of the internal configuration shown in FIG. 2;

FIG. 6 is a schematic front view of the internal configuration shown in FIG. 2;

FIG. 7 is a right side elevation view of the internal configuration shown in FIG. 2;

FIG. 8 is a block diagram schematically showing a relationship between a control unit, an image pick-up unit, and an image printing unit, in the internal configuration shown in FIG. 2;

FIG. 9 is a cross-sectional view of a first modification of the main body of the internal configuration of the nail printing apparatus according to the one embodiment of the present invention, schematically showing a state that a thumb of a left hand with a nail, on which a desired image is to be printed, is placed on a print target finger placing surface of a held portion, one of four fingers excepting the thumb of the left hand is placed on a non-print-target finger placing surface of the held portion while the remaining fingers of the four fingers stacking up on the one of the four fingers in a direction being away from the non-print-target finger placing surface, the held portion is held between the four fingers of the left hand and the thumb of the left hand, and the thumb is placed on the print target finger placing surface to stabilize its posture and to prevent it from moving;

FIG. 10A is a plan view of a second modification of the main body of the internal configuration of the nail printing apparatus according to the one embodiment of the present invention, schematically showing a state that four fingers with nails, on which desired images are to be printed, excepting a thumb of each of right and left hands are placed on and arranged along a print target finger placing surface of a held portion of a main body, a thumb of each of the right and left hands is placed on a non-print-target finger placing surface of the held portion, the held portion is held between the four fingers and the thumb of each of the right and left hands, and the four fingers of each of the right and left hands are placed on the print target finger placing surface to stabilize their posture and to prevent them from moving;

FIG. 10B is a plan view of the second modification of the main body of the internal configuration of the nail printing apparatus according to the one embodiment of the present invention, schematically showing a state that a thumb with a nail, on which a desired image is to be printed, of each of the right and left hands is placed on the print target finger placing surface of the held portion of the main body, the four fingers excepting the thumb of each of the right and left hands are placed on and arranged along the non-print-target finger placing surface of the held portion, the held portion is held between the four fingers and the thumb of each of the right and left hands, and the thumb of each of the right and left hands is placed on the print target finger placing surface to stabilize its posture and to prevent it from moving; and

FIG. 11 is a plan view of a third modification of the main body of the internal configuration of the nail printing apparatus according to the one embodiment of the present invention, schematically showing a state that a thumb with a nail, on which a desired image is to be printed, of each of a right and left hands is placed on a print target finger placing surface of a held portion of a main body, one of four fingers excepting the thumb of each of the right and left hands are placed on a non-print-target finger placing surface of the held portion while the remaining fingers of the four fingers are stacked up on the one of the four fingers in a direction being away from the non-print-target finger placing surface, the held portion is held between the four fingers and the thumb of each of the right and left hands, and the thumbs of the right and left hands are placed on the print target finger placing surface of the held portion of the main body to stabilize their postures and to prevent them from moving.

### DETAILED DESCRIPTION OF THE INVENTION

### One Embodiment

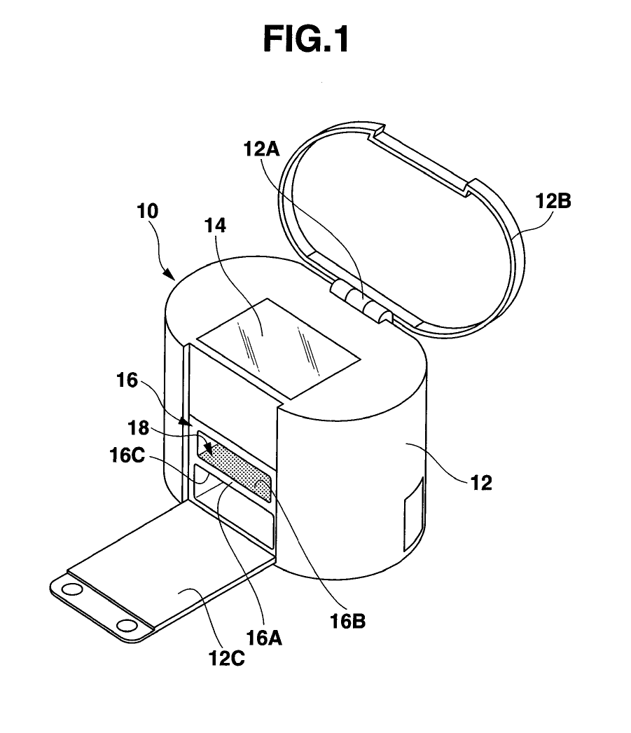

FIG. 1 schematically shows an appearance of a nail printing apparatus 10 according to one embodiment of the present invention.

An outer housing 12 of the nail printing apparatus 10 has an upper surface, a bottom surface, and a circumferential surface which connects the upper surface with the bottom surface. The outer housing 12 comprises an upper lid 12B coupled with the upper surface through a hinge 12A to be freely openable and closable and a front lid 12C coupled with a front part of the circumferential surface through a non-illustrated hinge to be freely openable and closable.

A control panel 14 including various switches and a display for a control unit configured to control operations of various structures of an internal configuration accommodated in an inner space of the outer housing 12 is arranged on the upper surface of the outer housing 12. The control panel 14 is covered with the upper lid 12B located in its closed position, and the control panel 14 can be operated when the upper lid 12B is opened as shown in FIG. 1.

An opening into which one hand of a user of the nail printing apparatus 10 can be inserted is formed in the front part of the circumferential surface of the outer housing 12. This opening is covered with the front lid 12C located in its closed position and is opened when the front lid 12B is opened as shown in FIG. 1.

A main body 16 of the internal configuration is stored in the opening. In this embodiment, the main body 16 has a hollow rectangular shape, and is opened in a direction facing the opening and in a direction facing the upper surface of the outer housing 12. An inner space of the main body 16 is partitioned into upper and lower parts by a held portion 16A. One surface of the held portion 16A, which is an upper surface in this embodiment, is called as a print target finger placing surface 16B, and the other surface, which is a lower surface in this embodiment, is called as a non-print-target finger placing surface 16C.

In this specification, it is considered that the thumb is one kind of fingers and one hand has first to fifth fingers. In this case, the thumb is the first finger, the second finger is an index finger, the third finger is a middle finger, the fourth finger is a ring finger, and the fifth finger is a little finger.

A thumb or four fingers excluding the thumb of the one hand of the user can be inserted into the upper part of the inner space of the main body 16 along the print target finger placing surface 16B, and the thumb or four fingers of the one hand of the user inserted into the upper part can be placed on the print target finger placing surface 16B.

At the same time, the four fingers or thumb of the one hand of the user can be inserted into the lower part of the inner space of the main body 16 along the non-print-target finger placing surface 16C, and the four fingers or thumb of the one hand of the user inserted into the lower part can be placed on the non-print-target finger placing surface 16C.

The thumb or four fingers of the one hand of the user placed on the print target finger placing surface 16B of the held portion 16A and the four fingers or thumb of the one hand of the user placed on the non-print-target finger placing surface 16C can hold the held portion 16A.

Based on this holding, a posture of the thumb or each of four fingers of the one hand of the user placed on the print target finger placing surface 16B is stabilized, thereby preventing its position from moving. Furthermore, the thumb or four fingers of the one hand of the user can be easily moved on the print target finger placing surface 16B even if unintentional force is applied to the thumb or four fingers of the one hand of the user placed on the print target finger placing surface 16B, whereby pain is not produced in the thumb or four fingers.

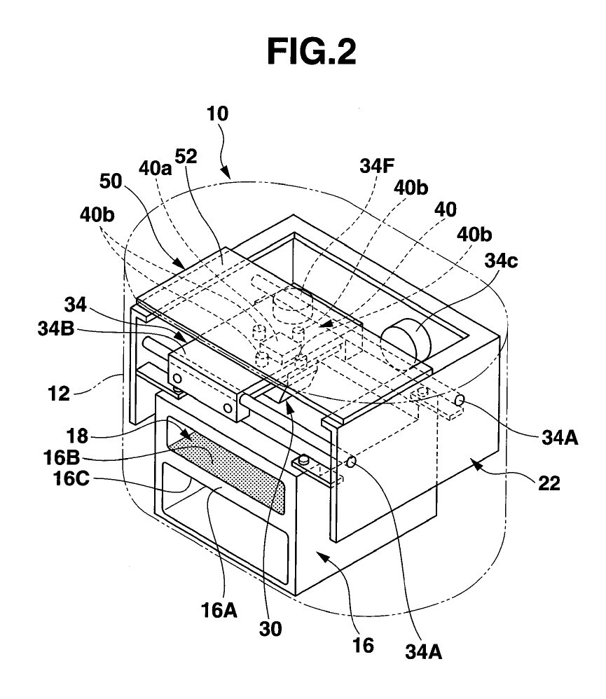

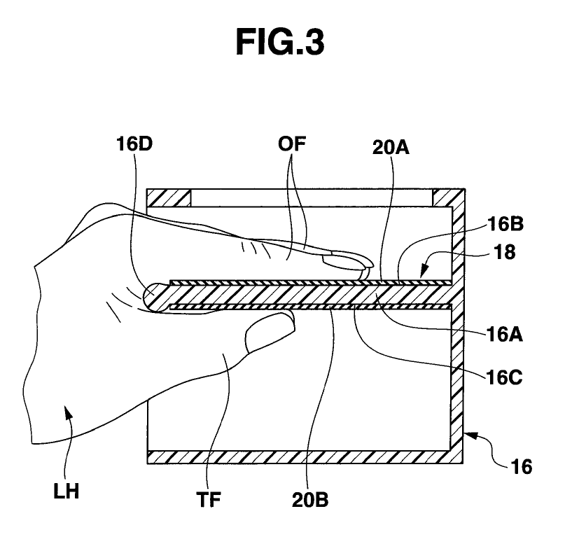

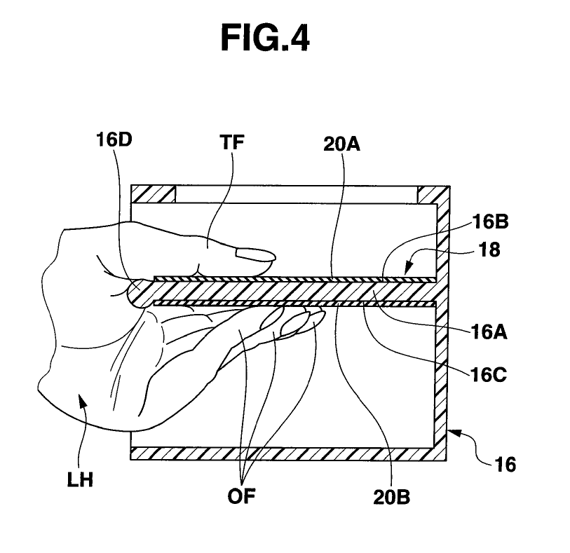

FIG. 2 schematically shows an internal configuration of the nail printing apparatus 10 shown in FIG. 1, and FIG. 3 and FIG. 4 schematically show the same cross sections of the main body 16 of the internal configuration in back-and-fourth directions of the main body 16.

FIG. 3 shows a state that a left hand LH as the one hand of the user is inserted into the inner space of the main body 16 through the opening positioned in the front part of the circumferential surface of the outer housing 12, and the four fingers OF excepting the thumb TF of the left hand LH are inserted into the upper part of the inner space while the thumb TF of the left hand LH is inserted into the lower part of the inner space. In the upper part, the four fingers OF are placed on and arranged along the print target finger placing surface 16B, and, in the lower part, the thumb TF is placed on the non-print-target finger placing surface 16C.

Moreover, FIG. 4 shows a state that the left hand LH of the user as the one hand is inserted into the inner space of the main body 16 through the opening positioned in the front part of the circumferential surface of the outer housing 12, and the thumb TF of the left hand LH is inserted into the upper part of the inner space and the four fingers OF excluding the thumb TH of the left hand LH are inserted into the lower part of the inner space. In the upper part, the thumb TH is placed on the print target finger placing surface 16B and the four fingers OF excluding the thumb TF of the left hand LH are placed on the non-print-target finger placing surface 16C.

According to an aspect of the present invention, a non-illustrated right hand may be inserted into the inner space of the main body 16 through the opening positioned in the front part of the circumferential surface of the outer housing 12, and a thumb of the right hand may be inserted into the upper part of the inner space to be placed on the print target finger placing surface 16B of the held portion 16A while four fingers excluding the thumb of the right hand may be inserted into the lower part of the inner space to be placed on and arranged along the non-print-target finger placing surface 16C of the held portion 16A. Further, the thumb of the right hand may be inserted into the lower part of the inner space to be placed on the non-print-target finger placing surface 16C of the held portion 16A while the four fingers excluding the thumb of the right hand may be inserted into the upper part of the inner space to be placed on and arranged along the print target finger placing surface 16B of the held portion 16A.

A slip stopper 18 is provided on at least one of the print target finger placing surface 16B and the non-print-target finger placing surface 16C of the held portion 16A.

The slip stopper 18 may be arbitrary shaped antislip grooves directly formed on the at least one of these surfaces, it may be provided by attaching a plate-like member having one surface on which arbitrary shaped antislip grooves are formed to the at lest one of the surfaces, or it may be provided by attaching a layer of an arbitrary antislip material to the at least one of the surfaces. As the antislip material, there is, e.g., a low-resistance elastic material such as flexible urethane foam or rubber.

The slip stopper 18 does not have to be provided on the whole part of the at least one of the print target finger placing surface 16B and the non-print-target finger placing surface 16C. The slip stopper 18 may be provided on a part of the at least one of the print target finger placing surface 16B and the non-print-target finger placing surface 16C, on that part at least one finger of a user being to be placed.

In this embodiment, as shown in FIG. 3 and FIG. 4, antislip material layers 20A and 20B are attached to both the print target finger placing surface 16B and the non-print-target finger placing surface 16C of the held portion 16A. Both the antislip material layers 20A and 20B on the print target finger placing surface 16B and the non-print-target finger placing surface 16C may be made of the same material. However, in this embodiment, the antislip material layer 20A attached to the print target finger placing surface 16B is a low-resistance elastic layer of, e.g., flexible urethane foam, and the antislip material layer 20B attached to the non-print-target finger placing surface 16C is, e.g., a rubber layer.

In such a configuration, when the held portion 16A is held between the thumb of the one hand of the user placed on one of the print target finger placing surface 16B and the non-print-target finger placing surface 16C and the four fingers excluding the thumb thereof placed on the other of the print target finger placing surface 16B and the non-print-target finger placing surface 16C as shown in FIG. 3 and FIG. 4, the print target finger placing surface 16B and non-print-target finger placing surface 16C of the held portion 16A can be stably grasped by just producing light holding force in the one hand.

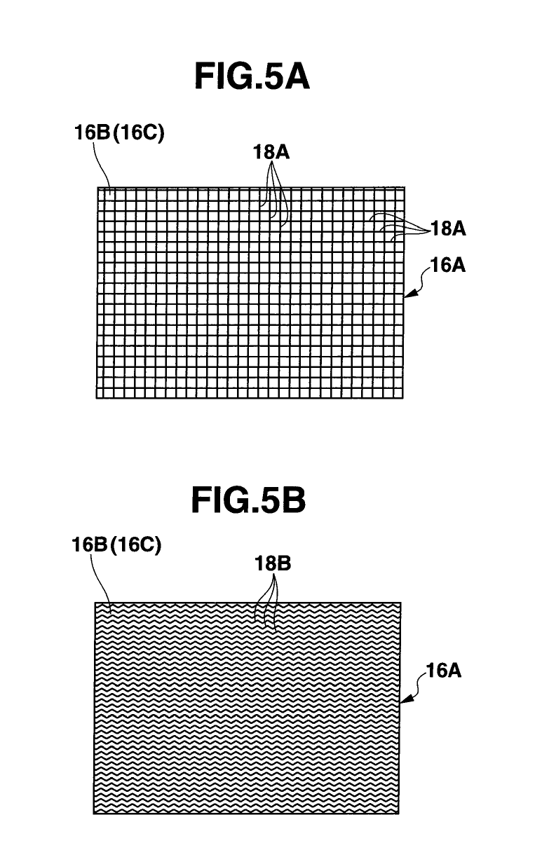

FIG. 5A and FIG. 5B show two shapes of the antislip grooves. Antislip grooves 18A in FIG. 5A have a so-called lattice shape, and antislip grooves 18B in FIG. 5B have a so-called corrugated shape.

As well shown in FIG. 3 and FIG. 4, a bulge 16D is provided on a side part of the held portion 16A, the side part facing a base of the thumb of the one hand of the user who places the thumb and the four fingers on the print target finger placing surface 16B and the non-print-target finger placing surface 16C. In this embodiment, the side part of the held portion 16A is a front end thereof exposed to the opening in the front part of the circumferential surface of the outer housing 12 as shown in FIG. 1 and FIG. 2. And, the bulge 16D bulges in a direction crossing each of the print target finger placing surface 16B and the non-print-target finger placing surface 16C and being away from at least one of the print target finger placing surface 16B and the non-print-target finger placing surface 16C. A thickness of the bulge 16D is preferably from 1 cm to 2 cm, and a thickness of the held portion 16A between the print target finger placing surface 163 and the non-print-target finger placing surface 16C is preferably set to be 0.5 cm to 1 cm smaller than the thickness of the bulge 16D.

The bulge 16D may bulge only in a direction being away from one of the print target finger placing surface 16B and the non-print-target finger placing surface 16C, or may bulge in both directions being away from both the print target finger placing surface 16B and the non-print-target finger placing surface 16C.

The base of the thumb of the one hand of the user who places the first finger and four fingers on the print target finger placing surface 16B and non-print-target finger placing surface 16C of the held portion 16A abuts on the bulge 16D, and this bulge 16D is wrapped in the base of the thumb. As a result, a position of the base of the thumb on the bulge 16 of the held portion 16A is stabilized, and hence positions of the thumb and four fingers on the print target finger placing surface 16B and non-print-target finger placing surface 16C of the held portion 16A can be further stabilized.

A cross-sectional shape of the bulge 16D is not restricted to such a circular shape as shown in FIG. 3 and FIG. 4. In short, if the position of the base of the thumb on the bulge 16D of the held portion 16A can be stabilized, the bulge 16D may have an elliptic cross-sectional shape, a polygonal cross-sectional shape, or a complicated cross-sectional shape obtained by combining curved surfaces or straight lines.

Additionally, the entire shape of the bulge 16D may be an ergonomic shape adapted to the base of the thumb of the hand.

As shown in FIG. 2, an image printing unit 30 is arranged between the main body 16 and an upper wall of the outer housing 12 in the inner space of the outer housing 12. The image printing unit 30 is configured to print a desired image on a nail of at least one finger placed on the print target finger placing surface 16B of the held portion 16A.

The nail printing apparatus 10 according to this embodiment further comprises an image pick-up unit 40 and a control unit 50 between the main body 16 and the upper wall of the outer housing 12 in the inner space of the outer housing 12. The image pick-up unit 40 is configured to pick up finger image data of at least one finger placed on the print target finger placing surface 16B of the held portion 16A of the main body 16, and the control unit 50 is configured to create nail data concerning a nail of the at least one finger from the finger image data and to control the image printing unit 30 based on this nail data to print a desired image on the nail of the at least one finger.

The control unit 50 is a control unit configured to control operations of various structures of the internal configuration accommodated in the inner space of the outer housing 12, and includes the control panel 14 arranged on the upper surface of the outer housing 12 as shown in FIG. 2.

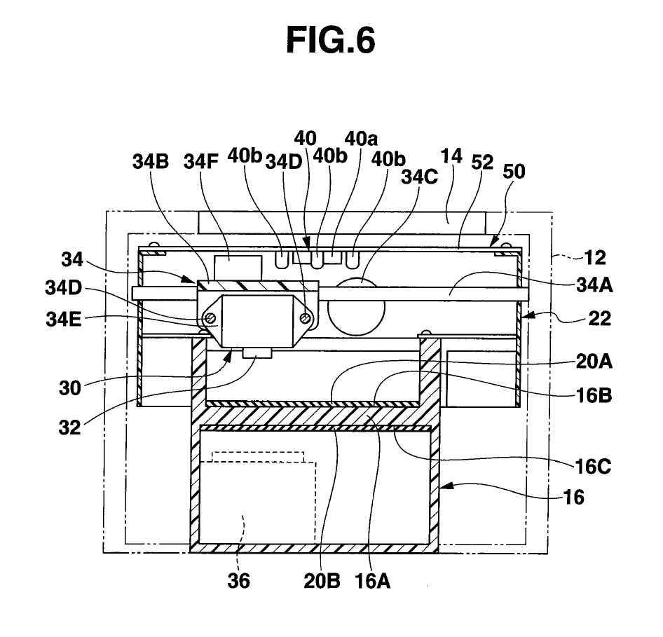

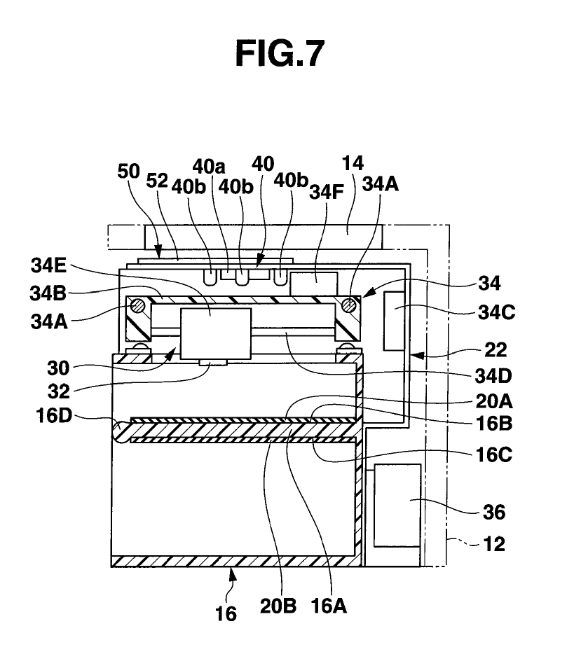

FIG. 6 schematically shows various structures accommodated in the inner space of the outer housing 12 in a vertical section along the front part of the circumferential wall of the outer housing 12, and FIG. 7 schematically shows the various structures accommodated in the inner space of the outer housing 12 in a vertical section in the back-and-fourth directions of the circumferential wall of the outer housing 12.

As shown in FIG. 2, FIG. 6, and FIG. 7, a support frame 22 is further arranged between the main body 16 and the upper wall of the outer housing 21 in the inner space of the outer housing 12. The support frame 22 surrounds an upper part of the main body 16 excepting a front part thereof, and is fixed to the upper part of the main body 16.

A circuit board 52 constituting one part of the control unit 50 is supported at an upper end of the support frame 22. Non-illustrated various electrical and electronic components are mounted on the circuit board 52.

A camera 40a and lighting means 40b for the image pick-up unit 40 are supported on a lower surface of the substrate 52. In this embodiment, the camera 40a is provided in the form of a CCD (Charge Coupled Device) camera, and the lighting means 40b is provided in the form of white LEDs arranged to surround the CCD camera. The camera 40a and lighting means 40b for the image pick-up unit 40 are electrically connected to the control unit 50 on the circuit board 52, and operations of the image pick-up unit 40 are controlled by the control unit 50. The image pick-up unit 40 obtains image data of at least one finger placed on the print target finger placing surface 16B of the held portion 16A by using the camera 40a while the lighting means 40b lights the at least one finger on the print target finger placing surface 16B, and the image pick-up unit 40 transmits the image data to the control unit 50.

Main part of the image printing unit 30 is further supported by the support frame 22. The main part of the image printing unit 30 includes a printing head 32 and a printing head movement guide mechanism 34. In this embodiment, the printing head 32 is configured to eject predetermined kinds of inks, and ink cartridges 36 storing the predetermined kinds of inks to be supplied to the printing head 32 are accommodated behind the main body 16 in the inner space of the outer housing 12. The ink cartridges 36 are connected to the printing head 32 through non-illustrated known flexible ink supply tubes arranged in the inner space of the outer housing 12, and the ink cartridges 36 and the non-illustrated ink supply tubes constitute one part of the image printing unit 30.

The printing head movement guide mechanism 34 is configured to move the printing head 32 above and along the print target finger placing surface 16B of the held portion 16A of the main body 16 to a desired position in response to an instruction from the control unit 50.

In this embodiment, the printing head movement guide mechanism 34 comprises two main guide rods 34A, a main carriage 34B, a main carriage drive motor 34C, and a non-illustrated known power transmission mechanism. The two main guide rods 34A are apart from each other in the back-and-fourth directions of the support frame 22 and extend in the right-and-left directions of the support frame 22 in parallel to each other. Both end portions of each of the two main guide rods 34A are supported on both right and left sidewalls of the support frame 22. The main carriage 34B is supported by the two main guide rods 34A to be movable in the right-and-left directions of the support frame 22. The main carriage drive motor 34C is supported on a rear wall of the support frame 22. And, the non-illustrated known power transmission mechanism is interposed between the main carriage drive motor 34C and the main carriage 34B and is configured to move the main carriage 34B on the two main guide rods 34A in the right-and-left directions of the support frame 22 in accordance with rotation of a non-illustrated output shaft of the main carriage drive motor 34C.

In this embodiment, the printing head movement guide mechanism 34 further comprises two sub-guide rods 34D, a sub-carriage 34E, and a non-illustrated known power transmission mechanism. The two sub-guide rods 34D are apart from each other in the right-and-left directions of the support frame 22 and extend in the back-and-fourth directions of the support frame body 22 in parallel to each other, and both end portions of each of the two sub-guide rods 34D are supported by the main carriage 34B. The sub-carriage 34E is supported by the two sub-guide rods 34D to be movable in the back-and-fourth directions of the support frame body 22. The sub-carriage drive motor 34F is supported by the sub-carriage 34F. And, the non-illustrated known power transmission mechanism is interposed between the sub-carriage drive motor 34F and the sub-carriage 34E and is configured to move the sub-carriage 34E on the two sub-guide rods 34D in the back-and-fourth directions of the support frame 22 in accordance with rotation of a non-illustrated output shaft of the sub-carriage drive motor 34F. The printing head 32 is supported by the sub-carriage 34E.

In the printing head movement guide mechanism 34 configured as described above, the control unit 50 controls the rotation of each of the main carriage drive motor 34C and the sub-carriage drive motor 34F to move the main carriage 34B in the right-and-left directions of the support frame body 22 and also to move the sub-carriage 34E in the back-and-fourth directions of the support frame body 22, whereby the printing head 32 supported by the sub-carriage 34E can be moved above and along the print target finger placing surface 16B of the held portion 16A of the main body 16 to a desired position.

The non-illustrated and above described various electrical and electronic components on the circuit board 52 of the control unit 50 include an ROM (Read Only Memory) and an RAM (Random Access Memory), store various images (which are various patterned images and will be referred as image patterns hereinafter in this embodiment) that can be printed by the image printing unit 30, a nail data creating program, an image printing unit program, etc., and constitute a control circuit 50A for executing these programs. The control circuit 50A can create nail data concerning a nail of the at least one finger based on the image data through the nail data creating program from the image pick-up unit 40 concerning the at least one finger placed on the print target finger placing surface 16B of the held portion 16A, and can make the image printing unit 30 through the image printing unit program to print a selected image pattern on the nail of the at least one finger based on the nail data.

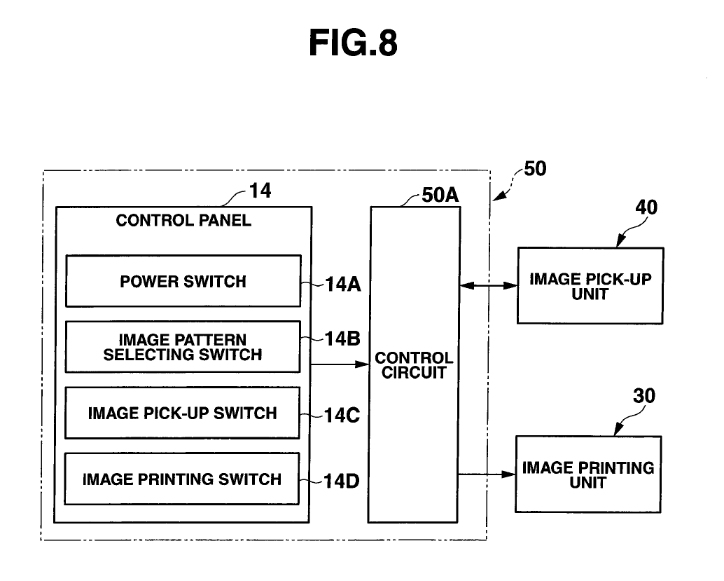

FIG. 8 schematically shows a relationship between the control circuit 50A and the control panel 14 in the control unit 50, and relationships between the control circuit 50A in the control unit 50, the image pick-up unit 40, and the image printing unit 30. As shown in FIG. 8, a power switch 14A, an image pattern selecting switch 14B, an image pick-up switch 14C, and an image printing switch 14D are arranged in the control panel 14 according to this embodiment.

When printing at least one of the various image patterns on a nail of at least one finger of one hand of a user by the nail printing apparatus 10 according to one embodiment of the present invention, the nail printing apparatus 10 is set to a use state shown in FIG. 1, and the power switch 14A is turned on.

Further, the one hand of the user is inserted into the front opening of the main body 16 through the opening exposed in the front part of the circumferential wall of the outer housing 12, at least one finger including the nail on which the at least one image pattern is to be printed in the one hand is placed on the print target finger placing surface 6B of the held portion 16A, at least one finger including a nail on which the image pattern is not to be printed in the one hand is placed on the non-print-target finger placing surface 16C of the held portion 16A, and the held portion 16A is held between these fingers. This holding stabilizes a posture and position of the at least one finger on the print target finger placing surface 16B of the held portion 16A.

Then, when the image pick-up switch 14C is turned on, the control circuit 50A of the control unit 50 sets the image pick-up unit 40 to pick up image data of the at least one finger placed on the print target finger placing surface 16B of the held portion 16A as described above. The control circuit 50A creates nail data concerning the nail of the at least one finger placed on the print target finger placing surface 16B as described above, based on the image data. This nail data includes data of a position of the nail on the print target finger placing surface 16B.

When at least one image pattern which is to be printed on the nail of the at least one finger placed on the print target finger placing surface 16B of the held portion 16A of the main body 16 is selected from the various image patterns previously stored in the control circuit 50A by using the image pattern selecting switch 14B and then the image printing switch 14D is turned on, the control circuit 50A controls the image printing unit 30 to print the selected at least one image pattern on the nail of the at least one finger.

Here, for example, if a plurality of fingers is placed on the print target finger placing surface 16B of the held portion 16A as shown in FIG. 3, the control circuit 50A of the control unit 50 can set the image pick-up unit 40 to pick up image data of these fingers.

Further, for example, if a plurality of fingers is placed on the print target finger placing surface 16B of the held portion 16A as shown in FIG. 3, the control circuit 50A of the control unit 50 can set the image pattern selecting switch 14B to arbitrarily select image patters which are to be printed on respective nails of these fingers. The image patterns which are to be printed on the nails may be different from or equal to each other.

Moreover, for example, if a plurality of fingers is placed on the print target finger placing surface 16B of the held portion 16A as shown in FIG. 3, the control circuit 50A of the control unit 50 can set the image printing unit 30 to print the image patterns selected for the nails of the fingers on the nails continuously by turning on the image printing switch 14D once.

The control circuit 50A of the control unit 50 can be configured to start automatically obtaining image data for the thumb TF or four fingers OF on the print target finger placing surface 16B by the image pick-up unit 40, creating nail data of the thumb TF or each of the four fingers OF based on the image data, and printing an image pattern selected for the thumb TF or each of the four fingers OF by the image printing unit 30, by only placing the thumb TF or four fingers OF of the one hand on the print target finger placing surface 16B of the held portion 16A, after the power switch 14A of the control panel 14 is turned on, the image pattern selecting switch 14B is operated to select the image pattern which is to be printed on the thumb TF or each of the four fingers OF of the left hand LH or a right hand of the user, and the image pick-up switch 14C and the image printing switch 14D are turned on.

[First Modification]

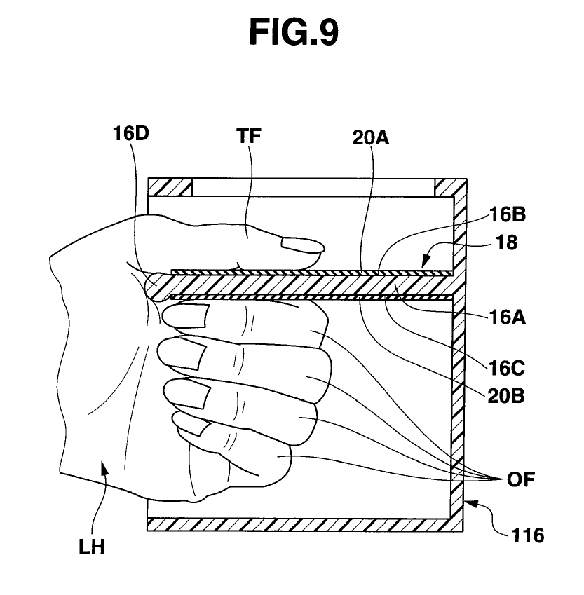

A first modification of the nail printing apparatus 10 according to the one embodiment described above with reference to FIG. 1 to FIG. 8 will now be described with reference to FIG. 9.

This modification is different from the nail printing apparatus 10 according to the one embodiment in a dimension of a main body 116. In more detail, a vertical dimension of an inner space of the main body 116 according to this modification is set in such a manner that one fist of a user can be inserted into the inner space in such a posture that five fingers of the one fist are stacked in a vertical direction. As shown in FIG. 9, the inner space is partitioned by a held portion 16A into upper and lower parts, and a thumb TF of the one fist of the user inserted in the above described posture can be arranged in the upper part of the inner space and can be placed on a print target finger placing surface 16B of the held portion 16A while four fingers OF excluding the thumb TF of the one fist of the user inserted in the above-described posture can be arranged in the lower part of the inner space and can be stacking on a non-print-target finger placing surface 16C of the held portion 16A in a direction being away from the non-print-target finger placing surface 16C (a lower direction in this modification). Here, a side of a second finger alone in the four fingers OF is placed on the non-print-target finger placing surface 16C. And, the held portion 16A of the main body 116 is held between the thumb TF of the one fist of the user placed on the print target finger placing surface 16B and the second finger placed on the non-print-target finger placing surface 16C.

Here, the one hand may be a right hand or a left hand of the user. FIG. 9 shows the left hand LH of the user.

Also, in this modification, as shown in FIG. 3, the four fingers excluding the thumb of the one hand of the user can be placed on and arranged along the print target finger placing surface 16B of the held portion 16A, and, at the same time, the thumb of the one hand can be placed on the non-print-target finger placing surface 16C. Moreover, as shown in FIG. 4, the thumb of the one hand of the user can be placed on the print target finger placing surface 16B of the held portion 16A, and, at the same time, the four fingers excluding the thumb of the one hand can be placed on and arranged along the non-print-target finger placing surface 16C.

[Second Modification]

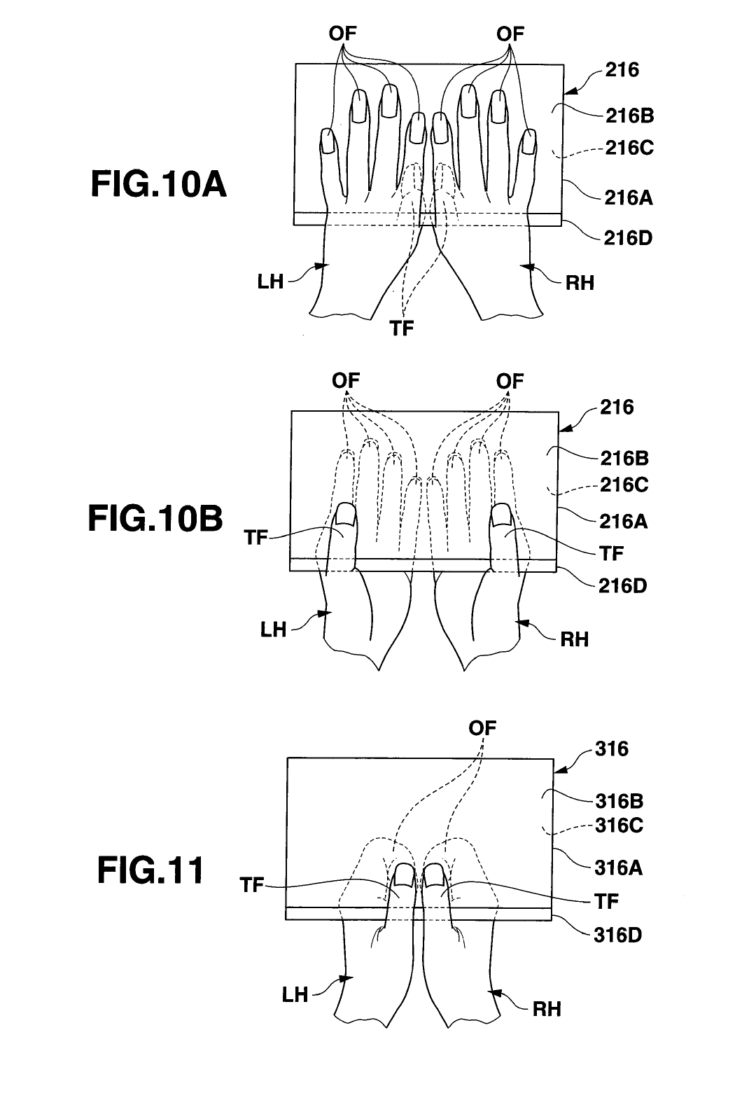

A second modification of the nail printing apparatus 10 according to the one embodiment described above with reference to FIG. 1 to FIG. 8 will now be described with reference to FIG. 10A and FIG. 10B.

This modification is different from the nail printing apparatus 10 according to the one embodiment in a dimension of a main body 216. In detail, as shown in FIG. 10A, a dimension of a held portion 216A of the main body 216 in right-and-left directions is set in such a manner that four fingers OF excluding a thumb TF of right hand RH of a user and those of left hand LH of the user can be placed side by side on and arranged along a print target finger placing surface 216B. In this case, both of the thumbs TF of the right and left hands RH and LH of the user are placed side by side on a non-print-target finger placing surface 216C.

In this modification, as shown in FIG. 10B, the four fingers OF excluding the thumb TF of the right hand RH of the user and those of the left hand LH of the user can be placed side by side on and arranged along the non-print-target placing surface 216C of the held portion 216. In this case, both of the thumbs TF of the right and left hands RH and LH of the user can be placed on the print target finger placing surface 216B while being apart from each other along the print target finger placing surface 216B.

In this modification, a bulge 216D of the held portion 216A is provided on at least parts of the held portion 216A facing bases of the thumbs TF on palms of the right and left hands RH and LH of the user while the thumb TF or the four fingers OF excluding the thumb TF of each of the right and left hands RH and LH is or are placed on the print target finger placing surface 216B.

In such a second modification, the control circuit 50A of the control unit 50 shown in FIG. 8 can be configured to start automatically obtaining image data for the thumb TF or four fingers OF of each of the right and left hands RH and LH on the print target finger placing surface 216B by the image pick-up unit 40, creating nail data of the thumb TF or each of the four fingers OF of each of the right and left hands RH and LH based on the image data, and printing an image pattern selected for the thumb TF or each of the four fingers OF of each of the right and left hands RH and LH by the image printing unit 30, by only placing the thumb TF or four fingers OF of each of the right and left hands RH and LH on the print target finger placing surface 216B of the held portion 216A, after the power switch 14A of the control panel 14 is turned on, the image pattern selecting switch 14B is operated to select the image pattern which is to be printed on the thumb TF or each of the four fingers OF of each of the right and left hands RH and LH of the user, and the image pick-up switch 14C and the image printing switch 14D are turned on.

[Third Modification]

A third modification of the nail printing apparatus 10 according to the one embodiment described above with reference to FIG. 1 to FIG. 8 will now be described with reference to FIG. 11.

This modification is different from the nail printing apparatus 10 according to the one embodiment in a dimension of a main body 316. In detail, as shown in FIG. 11, the main body 316 is configured in such a manner that thumbs TF, that is first fingers, of right and left hands RH and LH of a user can be placed side by side on a print target finger placing surface 316B of a held portion 316A of the main body 316 while a second finger of four fingers OH excluding the thumb TF of each of the right and left hands RH and LH of the user can be placed on a non-print-target finger placing surface 316C and remaining fingers, that is third to fifth fingers, of the four fingers are stacked up on the second finger in a direction being away from the non-print-target finger placing surface 316C of the held portion 316A, and the stacked-up four fingers OF of each of the right and left hands RH and LH can be arranged side by side to be adjacent to each other.

Further, a dimension of the print target finger placing surface 316B in right and left directions is set in such a manner that the four fingers OF excluding the thumb TF of the right left hand RH of the user and those of the left hand LH of the user can be placed on and arranged side by side along the print target finger placing surface 316B, as shown in FIG. 10A.

Also in this modification, a bulge 316D of the held portion 316A is provided on at least parts of the held portion 316A facing bases of the thumbs on palms of the right and left hands RH and LH of the user while the thumb TF or the four fingers OF excluding the thumb TF of each of the right and left hands RH and LH is or are placed on the print target finger placing surface 316B.

In such a third modification, the control circuit 50A of the control unit 50 shown in FIG. 8 can be configured to start automatically obtaining image data for the thumb TF or four fingers OF of each of the right and left hands RH and LH on the print target finger placing surface 316B by the image pick-up unit 40, creating nail data of the thumb TF or each of the four fingers OF of each of the right and left hands RH and LH based on the image data, and printing an image pattern selected for the thumb TF or each of the four fingers OF of each of the right and left hands RH and LH by the image printing unit 30, by only placing the thumb TF or four fingers OF of each of the right and left hands RH and LH on the print target finger placing surface 316B of the held portion 316A, after the power switch 14A of the control panel 14 is turned on, the image pattern selecting switch 14B is operated to select the image pattern which is to be printed on the thumb TF or each of the four fingers OF of each of the right and left hands RH and LH of the user, and the image pick-up switch 14C and the image printing switch 14D are turned on.

Additional advantages and modifications will be readily occur to those skilled in the art. Therefore, the invention in its broader aspects is not limited to the specific details and representative embodiment shown and described herein. Accordingly, various modifications may be made without departing from the spirit or scope of the general inventive concept as defined by the appended claims and their equivalents.

What is claimed is:

1. A nail printing apparatus comprising:
a main body including a held portion which has a print target finger placing surface and a non-print-target finger placing surface, the print target finger placing surface being configured in such a manner that at least one finger with a nail, on which a desired image is to be printed, of one hand is placed thereon, the non-print-target finger placing surface being configured in such a manner that at least one remaining finger of the one hand is placed thereon, and the held portion being held between the at least one finger placed on the print target finger placing surface and the at least one remaining finger placed on the non-print-target placing surface; and
an image printing unit configured to print the desired image on the nail of the at least one finger placed on the print target finger placing surface of the held portion of the main body.

2. The nail printing apparatus according to claim 1, wherein a slip stopper is provided on at least one of the print target finger placing surface and the non-print-target finger placing surface.

3. The nail printing apparatus according to claim 2, wherein the slip stopper is provided in the form of antislip grooves formed on the at least one of the surfaces.

4. The nail printing apparatus according to claim 2, wherein the slip stopper is provided in the form of a low-resistance elastic layer arranged on the at least one of the surfaces.

5. The nail printing apparatus according to claim 2, wherein the slip stopper is provided on the print target finger placing surface.

6. The nail printing apparatus according to claim 5, wherein the slip stopper is provided in the form of antislip grooves formed on the print target finger placing surface.

7. The nail printing apparatus according to claim 5, wherein the slip stopper is provided in the form of a low-resistance elastic layer arranged on the print target finger placing surface.

8. The nail printing apparatus according to claim 7, wherein a slip stopper provided with a rubber layer is arranged on the non-print-target finger placing surface.

9. The nail printing apparatus according to claim 1, wherein the print target finger placing surface is configured in such a manner that a thumb of the one hand is placed thereon, and the non-print-target placing surface is configured in such a manner that at least one of fingers excluding the thumb of the one hand is placed thereon.

10. The nail printing apparatus according to claim 9, wherein the non-print-target finger placing surface is configured in such a manner that all the fingers excluding the thumb of the one hand are placed on the non-print-target finger placing surface while being arranged along the non-print-target finger placing surface.

11. The nail printing apparatus according to claim 9, wherein the non-print-target finger placing surface is configured in such a manner that one of the fingers excluding the thumb of the one hand is placed on the non-print-target finger placing surface and the remaining fingers are stacked up on the one finger placed on the non-print-target finger placing surface in a direction being away from the non-print-target finger placing surface.

12. The nail printing apparatus according to claim 1, wherein
the print target finger placing surface is configured in such a manner that the fingers excluding a thumb of the one hand are placed on and arranged along the print target finger placing surface,
the non-print-target finger placing surface is configured in such a manner that the thumb of the one hand is placed on the non-print-target finger placing surface, and
the image printing unit is configured to enable printing a desired image on each of nails of the fingers placed on the print target finger placing surface of the held portion of the main body.

13. The nail printing apparatus according to claim 1, wherein
the print target finger placing surface is configured in such a manner that the at least one finger with the nail, on which the desired image is to be printed, of the one hand is placed thereon and at least one finger with a nail, on which a desired image is to be printed, of another hand is further placed thereon,
the non-print-target finger placing surface is configured in such a manner that the at least one remaining finger of the one hand is placed thereon and at least one remaining finger of the other hand is further placed thereon, and
the image printing unit is configured to print the desired image on the nail of the at least one finger of the one hand placed on the print target finger placing surface of the held portion of the main body and to print a desired image on the nail of the at least one finger of the other hand placed on the print target finger placing surface.

14. The nail printing apparatus according to claim 13, wherein
the print target finger placing surface is configured in such a manner that a thumb of the one hand is placed thereon and a thumb of the other hand is placed thereon,
the non-print-target finger placing surface is configured in such a manner that at least one of the fingers excluding the thumb of the one hand is placed thereon and at least one of the fingers excluding the thumb of the other hand is placed thereon, and
the image printing unit is configured to print a desired image on a nail of the thumb of the one hand placed on the print target finger placing surface of the held portion of the main body and to print a desired image on a nail of the thumb finger of the other hand placed on the print target finger placing surface.

15. The nail printing apparatus according to claim 14, wherein
the non-print-target finger placing surface is configured in such a manner that all the fingers excluding the thumb of the one hand are placed thereon while being arranged along the non-print-target finger placing surface, and
the non-print-target finger placing surface is further configured in such a manner that all the fingers excluding the thumb of the other hand are placed thereon while being arranged along the non-print-target finger placing surface.

16. The nail printing apparatus according to claim 14, wherein
the non-print-target finger placing surface is configured in such a manner that one of the fingers excluding the thumb of the one hand is placed thereon and the remaining fingers of the one hand stack up on the one finger placed thereon in a direction being away from the non-print-target finger placing surface, and
the non-print-target finger placing surface is further configured in such a manner that one of the fingers excluding the thumb of the other hand is placed thereon and the remaining fingers of the other hand stack up on the one finger placed thereon in a direction being away from the non-print-target finger placing surface.

17. The nail printing apparatus according to claim 13,
wherein the print target finger placing surface is configured in such a manner that the fingers excluding a thumb of the one hand are placed thereon while being arranged along the print target finger placing surface and the fingers excluding a thumb of the other hand are placed thereon while being arranged along the print target finger placing surface,
the non-print-target finger placing surface is configured in such a manner that the thumb of the one hand is placed thereon and the thumb of the other hand is placed thereon, and
the image printing unit is configured to print desired images on respective nails of the fingers of the one hand and on respective nails of the fingers of the other hand placed on the print target finger placing surface of the held portion of the main body.

18. The nail printing apparatus according to claim 1, wherein a side part of the held portion of the main body facing a base of a thumb of the one hand bulges to be away from at least one of the print target finger placing surface and the non-print-target finger placing surface in a direction crossing each of the print target finger placing surface and the non-print-target finger placing surface of the held portion.

19. The nail printing apparatus according to claim 13, wherein a side part of the held portion of the main body facing a base of a thumb of the one hand and a base of a thumb of the other hand bulges to be away from at least one of the print target finger placing surface and the non-print-target finger placing surface in a direction crossing each of the print target finger placing surface and the non-print-target finger placing surface of the held portion.

20. The nail printing apparatus according to claim 1, comprising:
an image pick-up unit which picks up finger image data of the at least one finger placed on the print target finger placing surface of the held portion of the main body; and a control unit which creates nail data concerning a nail of the at least one finger from the finger image data and which controls the image printing unit based on the nail data to print a desired image on the nail of the at least one finger.
